(19) United States
(12) Patent Application Publication
(10) Pub. No.: US 2010/0050166 A1
(43) Pub. Date: Feb. 25, 2010

(54) Updating system and method of portable executable programs

(75) Inventors: Chaucer Chiu, Taipei (TW); Jenny Xu, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/230,050

(22) Filed: Aug. 22, 2008

(51) Int. Cl. G06F 9/44; G06F 15/16

(52) U.S. Cl. 717/168

(57) ABSTRACT

An update system of a portable executable program and the method thereof are provided. By verifying a vendor identification code and machine identification code and checking information of the portable executable program, the system can update the portable executable program in a portable storage device. This solves the inconvenience problem in updating a portable executable program in a portable storage device that requires repeated registrations. Using the system and method, the portable executable program in a portable storage device can be updated without involving repeated registrations.

### BACKGROUND OF THE INVENTION

1. Field of Invention

The invention relates to an executable program updating system and the method thereof. In particular, the invention relates to the updating system and method of portable executable programs.

2. Related Art

Flash memory has gradually replaced electrically-erasable programmable read-only memory (EEPROM) or battery-powered memory in many portable storage devices due to its advantages of low power consumption, non-volatility, resistance to vibrations, and high storage densities. Thanks to advances in the semiconductor technology, the storage density and transmission speed of flash memory have improved a lot. Therefore, they can even replace conventional storage media such as hard disk drives (HDD).

Since flash memory has many functions and desirable properties mentioned above, new storage devices are invented based on that. Such flash memory storage devices enable users to rapidly store digital data in them as well as retrieve data stored therein. Data can thus be readily carried along. Their convenience makes it more competitive than most other conventional storage devices. Nowadays, flash memory storage devices have become an indispensable tool.

In addition to rapid data access for portable storage devices, application programs can be combined therein for uses. Such application programs are called portable executable programs. Due to the portability of the portable storage devices, the portable executable programs can thus be plug-n-play too.

In the prior art, the registration procedure and functions of a portable executable program are done by first installing the portable executable program, then entering the registration information such as the serial number thereof and the user's information. Only after this procedure can the portable executable program be updated or expanded in services.

However, for a portable executable program in a portable storage device, one has to go through the registration procedure of entering the serial number and user's information each time it is first used on a different computer. This is obviously very inconvenient in practice.

In summary, there has been a serious problem with repeated registrations for a portable executable program in a portable storage device. It is therefore imperative to provide an improved technique to solve this problem.

### SUMMARY OF THE INVENTION

In view of the foregoing, the invention discloses an updating system and method of portable executable programs.

According to the disclosed portable executable program updating system, the portable executable program is stored in a portable storage device and can be loaded into and run on a computer executable system. The disclosed portable executable program updating system includes: a server and a client. The server includes a receiving module, a comparing module, and a transmitting module. The client includes a data reading module, a connecting module, and an updating module.

The receiving module of the server receives a vendor identification code, a machine identification code, and portable executable program information. The comparing module compares the vendor identification code, the machine identification code, and the portable executable program information with data in an identification database. The transmitting module transmits update information when the vendor identification code, the machine identification code, and the portable executable program information are correct.

The portable executable program reads the vendor identification code and the machine identification code of the portable executable storage device from the hardware information thereof and reads the portable executable program information of the portable executable program. The connecting module connects to the server and transmits the vendor identification code, the machine identification code, and the portable executable program information to the server. It receives the update information from the server. The updating module updates the update information to the portable executable program.

According to the disclosed portable executable program updating method, the portable storage device stores a portable executable program. When the portable executable program is loaded into and run on a computer executable platform, the method includes the following steps.

First, the portable executable program at the client reads the vendor identification code and the machine identification code of the portable storage device from the hardware information thereof and read the portable executable program information of the portable executable program. Afterwards, the client connects to the server and transmits the vendor identification code, the machine identification code, and the portable executable program information to the server. The server receives the vendor identification code, the machine identification code, and the portable executable program information. Afterwards, the server compares the vendor identification code, the machine identification code, and the portable executable program information with the data in the identification database. When the vendor identification code, the machine identification code, and the portable executable program information are compared to be correct, the server transmits update information to the client. Afterwards, the client receives the update information. Finally, the client updates the update information to the portable executable program.

The disclosed system and method have been described above. The main difference with the prior art is that the invention reads the vendor identification code, the machine identification code, and the portable executable program information and transmits them to the server. The server checks the vendor identification code, the machine identification code, and the portable executable program information against data in the identification database. Once the identification is successful, the server transmits update information to the client. The client uses the update information to update the portable executable program. Following the above-mentioned procedure, the user does not need to go through the same registration procedure over and over again, while the portable executable program can be updated and expanded in services.

Using the above-mentioned technical means, the invention can achieve the goal of updating information of a portable executable program in a portable storage device without repeated registrations.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed updating system of a portable executable program;

FIG. 2 is a flowchart of the disclosed updating method of a portable executable program; and

FIG. 3 is a schematic view showing how to update a portable executable program according to the invention.

### DETAILED DESCRIPTION OF THE INVENTION

The present invention will be apparent from the following detailed description, which proceeds with reference to the accompanying drawings, wherein the same references relate to the same elements.

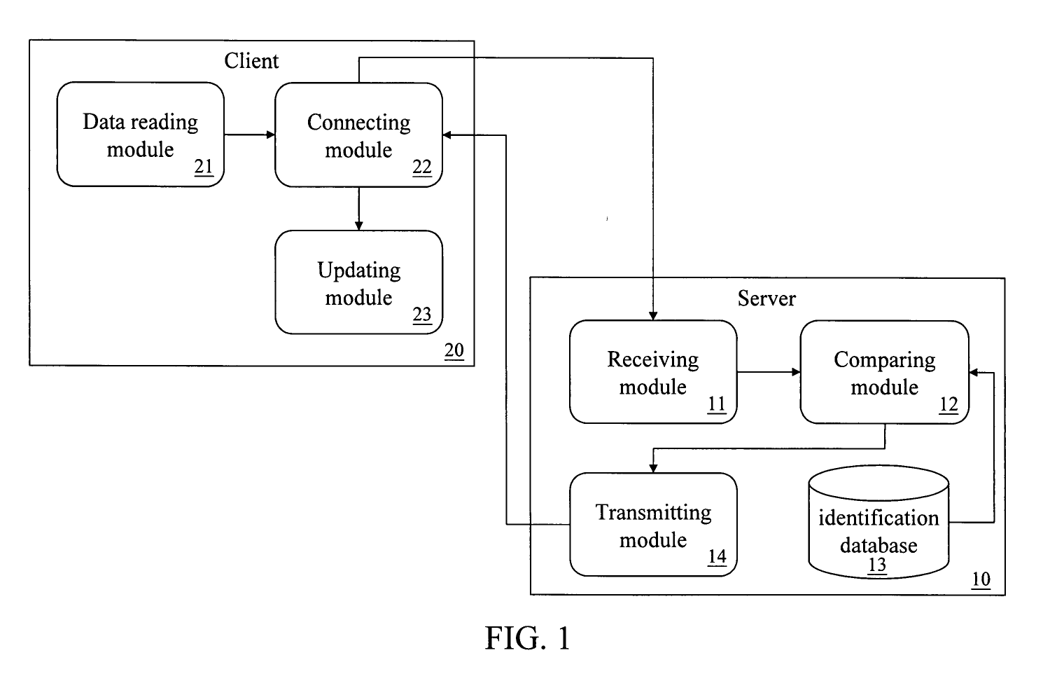

The following paragraphs refer to FIG. 1, a block diagram of the disclosed updating system of a portable executable program.

In the disclosed updating system of a portable executable program, the portable executable program is stored in a portable storage device. It can be loaded into a computer executable platform and run thereon. The disclosed updating system includes: a server 10 and a client 20. The server 10 has a receiving module 11, a comparing module 12, an identification database 13, and a transmitting module 14. The client 20 has a data reading module 21, a connecting module 22, and an updating module 23.

When the portable executable program starts running, the client 20 first communicates with the portable storage device about its hardware information via the data reading module 21. It reads the vendor identification code and the machine identification code of the portable storage device from the hardware information thereof. It further reads the portable executable program information of the portable executable program.

The vendor identification code is a vendor identification code of the controller chip of the storage device. Different vendors use different vendor identification codes. The vendor identification code is universal for the same vendor. Therefore, the vendor identification code depends upon the controller chip of the storage device.

The machine identification code is the product identification code of the portable storage device used by the vendor. Even though a vendor uses the same controller chip in all storage devices, the model numbers of different portable storage devices are different. Therefore, the machine identification codes of different portable storage devices made by the same vendor are different. The machine identification code depends upon the product model of the portable storage device.

The portable executable program information includes a portable executable program product code, a portable executable program version serial number, and a portable executable program version language. The portable executable program product code denotes the corresponding product of the portable executable program. The portable executable program version serial number represents the version of the portable executable program. The portable executable program version language represents the language used in the portable executable program.

The data reading module 21 reads the vendor identification code and the machine identification code of the portable storage device from the hardware information of the portable storage device and the portable executable program information of the portable executable program. The vendor identification code, the machine identification code, and the portable executable program information are transmitted to the connecting module 22. The connecting module 22 connects to the server 10. It transmits the vendor identification code, the machine identification code, and the portable executable program information to the server 10.

In addition to transmitting vendor identification code, the machine identification code, and the portable executable program information to the server 10, the connecting module 22 also receives update information from the server 10.

The update information includes an update program and update information for the portable executable program. The update program updates the version of the portable executable program. The update information updates the data used in the portable executable program, such as its database and record file.

After the connecting module 22 receives the update information transmitted from the server 10, it passes it over to the updating module 23. After receiving the update information, the updating module 23 updates the portable executable program or the data used by it according to the update information.

In addition to receiving the update information transmitted from the server 10, the connecting module 22 further receives terminating information transmitted from the server 10. After receiving the terminating information, the connecting module 22 passes it over to the updating module 23. The updating module 23 then terminates the updating procedure accordingly.

The server 10 first uses the receiving module 11 to receive the vendor identification code, the machine identification code, and the portable executable program information transmitted by the connecting module 22 of the client 20.

After receiving the vendor identification code, the machine identification code, and the portable executable program information, the receiving module 11 passes them to the comparing module 12. The comparing module 12 compares the vendor identification code, the machine identification code, and the portable executable program information with data in the identification database 13.

The comparing module 12 checks whether the vendor identification and the machine identification code are valid. It also checks the portable executable program information against the portable executable program version and the data used by the portable executable program in the server 10. It thereby finds the parts to be updated and integrates them into the update information.

When the comparison of the vendor identification code, the machine identification code, and the portable executable program information is successful, the update information is generated. The comparing module 12 then transmits the generated update information to the transmitting module 14. After receiving the update information, the transmitting module 14 transmits it to the client 20.

If the comparison of the vendor identification code, the machine identification code, and the portable executable program information fails, the terminating information is generated. The comparing module 12 transmits the generated terminating information to the transmitting module 14. After receiving the terminating information, the terminating module 14 transmits it to the client 20.

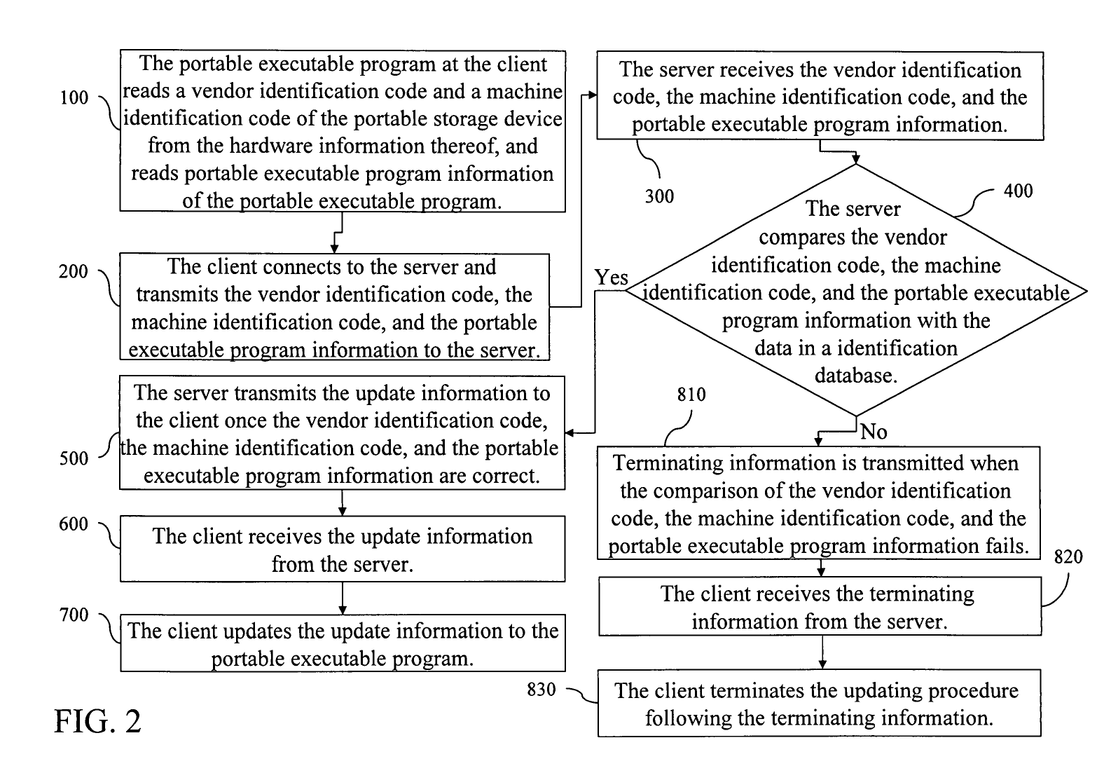

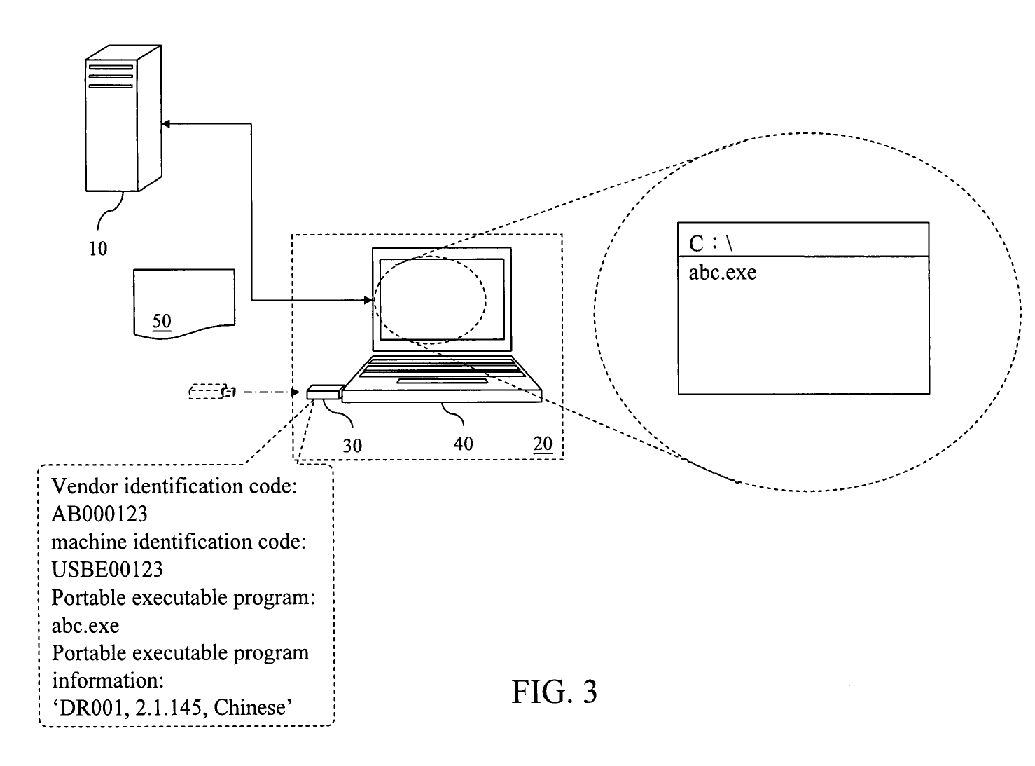

An embodiment with simultaneous reference to FIGS. 2 and 3 is used to explain the operation and procedure of the invention.

As shown in FIG. 3, the portable storage device 30 is electrically connected with a computer executable platform 40 via a universal serial bus (USB) port. The operating system (OS) in the computer executable platform 40 access data in the portable storage device 30 via the USB port. The client 20 includes the portable storage device 30 and the computer executable platform 40.

The computer executable platform 40 loads from the portable storage device 30 a portable executable program ‘abc.exe’ into a disk device letter ‘C:\’ and starts running the portable executable program ‘abc.exe’. First, its data reading module 21 communicates with the portable storage device 30 about its hardware information. From the hardware information of the portable storage device 30, the vendor identification code is ‘AB000123’, the machine identification code is ‘USBE00123’, and the portable executable program information is ‘DR001, 2.1.145, Chinese’. (Step 100)

The portable executable program information ‘DR001, 2.1.145, Chinese’ contains the portable executable program product code ‘DR001’, the portable executable program version serial number ‘2.1.145’, and the portable executable program version language ‘Chinese’.

Afterwards, the data reading module 21 transmits the vendor identification code ‘AB000123’, the machine identification code ‘USBE00123’, and the portable executable program information ‘DR001, 2.1.145, Chinese’ to the connecting module 22. The connecting module 22 connects to the server 10 and transmits the vendor identification code ‘AB000123’, the machine identification code ‘USBE00123’, and the portable executable program information ‘DR001, 2.1.145, Chinese’ to the server 10. (Step 200)

Afterwards, the server 10 receives the vendor identification code ‘AB000123’, the machine identification code ‘USBE00123’, and the portable executable program information ‘DR001, 2.1.145, Chinese’ transmitted from the connecting module 22 via the receiving module 11 (step 300). The vendor identification code ‘AB000123’, the machine identification code ‘USBE00123’, and the portable executable program information ‘DR001, 2.1.145, Chinese’ are transmitted to the comparing module 12.

The comparing module 12 checks the vendor identification code ‘AB000123’, the machine identification code ‘USBE00123’, and the portable executable program information ‘DR001, 2.1.145, Chinese’ against data stored in the identification database 13 (step 400). It checks one by one whether the vendor identification code and the machine identification code exist in the identification database 13. Concurrently, the vendor identification code and the machine identification code have to match with each other. If the above-mentioned conditions are satisfied, the vendor identification code and the machine identification code are determined to be valid.

After verifying that the vendor identification code and the machine identification code are valid, the comparing module 12 follows the portable executable program information ‘DR001, 2.1.145, Chinese’ to find in the identification database 13 the data corresponding to the portable executable program product code ‘DR001’ and the portable executable program version language ‘Chinese’. In the identification database 13, the portable executable program version is ‘2.2.001’. The data used by the portable executable program corresponding to version ‘2.2.001’ are also obtained. The comparing module 12 finds the version difference of the portable executable program. The parts to be updated are the portable executable program version ‘2.2.001’ and the corresponding portable executable program data. The comparing module 12 then integrates such information into the update information 50.

After the comparison of the vendor identification code, the machine identification code, and the portable executable program information is successful and the update information 50 is generated, the comparing module 12 transmits the generated update information 50 to the transmitting module 14. After receiving the update information 50, the transmitting module 14 transmits the update information to the client 20. (Step 500)

After the client 20 receives the update information 50 transmitted from the transmitting module 14 via the connecting module 22 (step 600), the update information 50 received by the connecting module 22 is passed over to the updating module 23.

Finally, the updating module 23 receives the update information 50. Since the update information 50 contains the portable executable program version ‘2.2.001’ and the portable executable program data corresponding to the version, the updating module 23 updates both the portable executable program version to ‘2.2.001’ and the portable executable program data. (Step 700)

Suppose the vendor identification code is ‘CD-123456’, the machine identification code is ‘SUSB-123456’, and the portable executable program information is ‘DR001, 2.1.145, Chinese’. The comparing module 12 compares the vendor identification code ‘CD-123456’, the machine identification code ‘SUSB-123456’, and the portable executable program information ‘DR001, 2.1.145, Chinese’ with data in the identification database 13. (Step 400)

First, the comparing module 12 checks one by one whether the vendor identification code ‘CD-123456’ and the machine identification code ‘SUSB-123456’ exist in the identification database 13. Moreover, the vendor identification code ‘CD-123456’ and the machine identification code ‘SUSB-123456’ have to match with each other. As a result, the vendor identification code ‘CD-123456’ and the machine identification code ‘SUSB-123456’ are determined to be invalid after the comparison. Afterwards, the comparing module 12 generates terminating information and transmits it to the transmitting module 14. After receiving the terminating information, the transmitting module 14 sends it to the client 20. (Step 810)

Afterwards, the client 20 receives the terminating information transmitted from the transmitting module 14 via the connecting module 22 (step 820). It then transmits the terminating information received by the connecting module 22 to the updating module 23.

Finally, after receiving the terminating information, the updating module 23 terminates the updating procedure (step 830).

In summary, the difference between the invention and the prior art is in that the invention reads the vendor identification code, the machine identification code, and the portable executable program information and transmits them to the server. The server checks the vendor identification code, the machine identification code, and the portable executable program information against data in the identification database. Once the identification is successful, the server transmits update information to the client. The client uses the update information to update the portable executable program. Following the above-mentioned procedure, the user does not need to go through the same registration procedure over and over again, while the portable executable program can be updated-and expanded in services.

Using the disclosed technique, the inconvenience in repeated registrations for updating a portable executable program in a portable storage device existing in the prior art can be resolved. Consequently, the portable executable program in the portable storage device can be updated without repeated registrations.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An updating system of a portable executable program stored in a portable storage device to be loaded into and run on a computer executable platform, comprising:
a server, which includes:
a receiving module, which receives a vendor identification code, a machine identification code, and portable executable program information;
a comparing module, which compares the vendor identification code, the machine identification code, and the portable executable program information with data in a identification database; and
a transmitting module, which transmits update information when the comparison of the vendor identification code, the machine identification code, and the portable executable program information is successful; and
a client, which includes:
a data reading module, which reads the vendor identification code and the machine identification code of the portable storage device from the hardware information of the portable storage device and reads the portable executable program information;
a connecting module, which connects to the server, transmits the vendor identification code, the machine identification code, and the portable executable program information to the server, and receives the update information from the server; and
an updating module, which updates the update information to the portable executable program.

2. The update system of claim 1, wherein the portable executable program information includes a portable executable program product code, a portable executable program version serial number, and a portable executable program version language.

3. The update system of claim 1, wherein the update information includes an update program and update data for the portable executable program.

4. The update system of claim 1, wherein the transmitting module sends terminating information when the comparison of the vendor identification code, the machine identification code, and the portable executable program information fails, the connecting module receives the terminating information, and the updating module includes an update termination procedure following the terminating information.

5. An updating method of a portable executable program stored in a portable storage device to be loaded into and run on a computer executable platform, comprising the steps of:
reading a vendor identification code and a machine identification code of the portable storage device from the hardware information thereof using the portable executable program at a client and reading portable executable program information of the portable executable program;
connecting the client to a server and transmitting the vendor identification code, the machine identification code, and the portable executable program information to the server;
receiving the vendor identification code, the machine identification code, and the portable executable program information by the server;
comparing the vendor identification code, the machine identification code, and the portable executable program information with data in an identification database using the server;
sending update information from the server to the client when the comparison of the vendor identification code, the machine identification code, and the portable executable program information is successful;
receiving the update information from the server at the client; and
updating the update information to the portable executable program at the client.

6. The updating method of claim 5, wherein the portable executable program information includes a portable executable program product code, a portable executable program version serial number, and a portable executable program version language.

7. The updating method of claim 5, wherein the update information includes an update program and update data for the portable executable program.

8. The updating method of claim 5 further comprising the steps of:
sending terminating information when the comparison of the vendor identification code, the machine identification code, and the portable executable program information fails;
receiving the terminating information from the server by the client; and
terminating the update procedure at the client following the terminating information.
